(19) United States
(12) Patent Application Publication
(10) Pub. No.: US 2026/0197101 A1
(43) Pub. Date: Jul. 9, 2026

(54) COMMUNICATION DEVICE AND COMMUNICATION METHOD

(71) Applicant: JVCKENWOOD Corporation, Yokohama-shi (JP)

(72) Inventors: Hideaki Shimoda, Yokohama-shi (JP); Akimi Iwasaki, Yokohama-shi (JP); Ryoji Kirihara, Yokohama-shi (JP)

(21) Appl. No.: 19/551,673

(22) Filed: Feb. 27, 2026

Related U.S. Application Data
(63) Continuation of application No. PCT/JP2024/026544, filed on Jul. 25, 2024.

(30) Foreign Application Priority Data
Aug. 28, 2023 (JP) 2023-137972

(51) Int. Cl. H04B 17/27; G01S 5/02; H04B 17/318; H04W 24/10

(52) U.S. Cl. CPC H04B 17/27; G01S 5/0284; H04B 17/318; H04W 24/10

(57) ABSTRACT

A communication device and a communication method are provided by which the distance between the communication device and a communication target device can be identified while maintaining stable connectivity between those devices. A communication device according to the application concerned includes a communication unit that performs wireless communication with another communication device; an obtaining unit that obtains a variety of information via the communication unit; and an output control unit that controls the transmission output value of the communication unit. The obtaining unit obtains, from the other communication device, second-type signals of second-type radio waves including first-type radio wave reception strength information, which represents the radio field strength value of first-type radio waves received by the other communication device from the communication device, and second-type radio wave transmission strength information, which represents the transmission output value of second-type radio waves transmitted by the other communication device. The output control unit controls the transmission output value of the first-type radio waves, which are transmitted to the other communication device, in such a way that the received first-type radio wave reception strength information is maintained at a constant level.

### CROSS-REFERENCE TO RELATED APPLICATIONS

This application is a Continuation of PCT International Application No. PCT/JP2024/026544 filed on Jul. 25, 2024 which claims the benefit of priority from Japanese Patent Application No. 2023-137972, filed on Aug. 28, 2023, the entire contents of both of which are incorporated herein by reference.

### BACKGROUND OF THE INVENTION

### 1. Field of the Invention

The application concerned is related to a communication device and a communication method.

### 2. Description of the Related Art

A technology is known by which, among the devices equipped with the wireless communication function, the radio waves transmitted from the target device are received and the received signal strength of the received radio waves is measured for estimating the distance to the target device.

For example, in Japanese Patent Application Laid-open No. 2016-62160 mentioned below, a technology is disclosed by which, in an RFID tag reading device, when a transmitting unit transmits radio waves based on transmission parameters corresponding to predetermined transmission conditions, a receiving unit receives response signals that are transmitted from an RFID tag in response to the transmitted radio waves. Subsequently, when a calculating unit calculates the received signal strength of the response signals, a distance estimating unit estimates the distance to the RFID tag based on the received signal strength and the transmission parameters.

However, regarding the technology for estimating the distance between devices according to the received signal strength as disclosed in the Japanese Patent Application Laid-open No. 2016-62160, since the received signal strength varies according to the distance between the devices, it is neither possible to maintain the communication quality between the devices at a constant level, nor it is possible to ensure uninterrupted communication even when there is an increase in the distance between the devices.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A communication device according to the present disclosure comprising: a communication unit that performs wireless communication with another communication device;

an obtaining unit that obtains a variety of information via the communication unit; and an output control unit that controls transmission output value of the communication unit, wherein the obtaining unit obtains, from the other communication device, second-type signal of second-type radio wave including first-type radio wave reception strength information, which represents radio field strength value of first-type radio wave received by the other communication device from the communication device, and second-type radio wave transmission strength information, which represents transmission output value of second-type radio wave transmitted by the other communication device, and the output control unit controls transmission output value of the first-type radio wave, which is transmitted to the other communication device, in such a way that the received first-type radio wave reception strength information is maintained at a constant level.

A communication method according to the present disclosure comprising: performing wireless communication with another communication device; obtaining a variety of information using the wireless communication; and

controlling transmission output value of the wireless communication, wherein the obtaining includes obtaining, from the other communication device, second-type signal of second-type radio wave that includes first-type radio wave reception strength information, which represents radio field strength value of first-type radio wave received by the other communication device from concerned communication device, and second-type radio wave transmission strength information, which represents transmission output value of the second-type radio wave transmitted by the other communication device, and the controlling includes controlling transmission output value of the first-type radio wave, which is transmitted to the other communication device, in such a way that the received first-type radio wave reception strength is maintained at a constant level.

### BRIEF DESCRIPTION OF THE DRAWINGS

FIG. 1 is a diagram for explaining the overview of a communication system according to the application concerned;

FIG. 2 is a diagram illustrating a configuration example of the communication system according to the application concerned;

FIG. 3 is a diagram illustrating a configuration example of a communication device according to the application concerned;

FIG. 4 is a diagram illustrating an example of the information stored in a connection information storing unit of the communication device according to the application concerned;

FIG. 5 is a diagram illustrating an example of the information stored in the setting value storing unit of the communication device according to the application concerned;

FIG. 6 is a diagram illustrating a configuration example of a communication target device according to the application concerned;

FIG. 7 is a flowchart for explaining the flow of a first way of implementation of a communication method according to the application concerned;

FIG. 8 is a flowchart for explaining the flow of a second way of implementation of the communication method according to the application concerned; and

FIG. 9 is a flowchart for explaining the flow of a implementation of a communication method performed in the communication system according to the application concerned.

### DETAILED DESCRIPTION OF THE PREFERRED EMBODIMENTS

An exemplary embodiment of the application concerned is described below in detail with reference to the accompanying drawings. However, the application concerned is not limited by the embodiment described below.

### Overview of Communication System

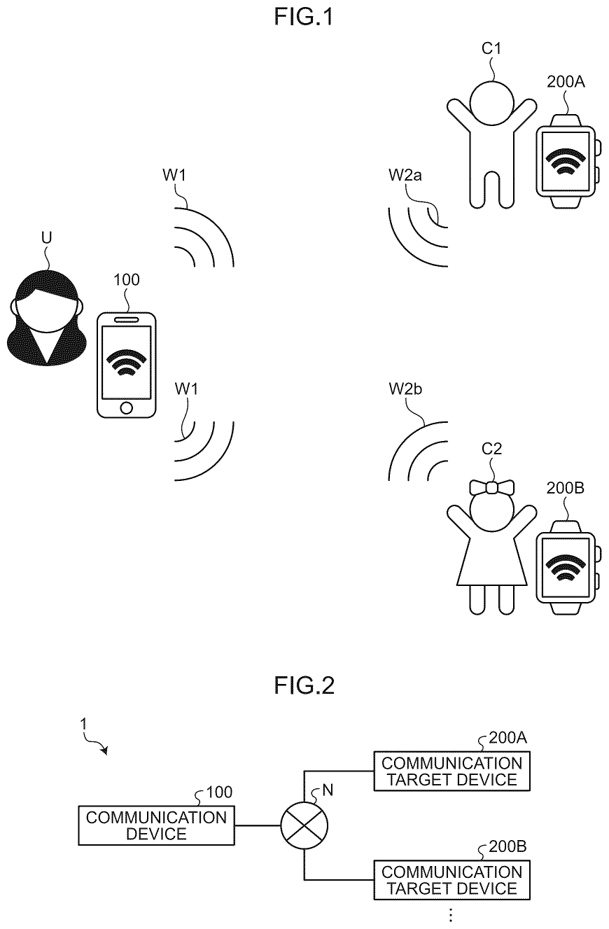

Firstly, explained below with reference to FIG. 1 is a scenario for implementing a communication system 1 according to the application concerned. FIG. 1 is a diagram for explaining the overview of the communication system according to the application concerned. As illustrated in FIG. 1, the communication system 1 according to the application concerned includes a communication device 100 and communication target devices 200 (200A and 200B). The communication device 100 and the communication target devices 200 can be communication devices of different types, such as the tablet type or the wristwatch type, but having identical functions. From the communication device 100, radio waves W1 are transmitted toward the communication target devices 200 (200A and 200B). Moreover, from the communication target device 200A, radio waves W2a are transmitted toward the communication device 100. Similarly, from the communication target device 200B, radio waves W2b are transmitted toward the communication device 100. The signals that are transmitted via the radio waves W1, W2a, and W2b include identifiers (device IDs) that enable identification of the transmission source of the radio waves and the destination of the radio waves. When the destination identifier specified in the signals matches with the identifier of the device that receives the radio waves, the device that receives the radio waves recognizes that the transmitted signals are intended for itself. For example, the signals transmitted via the radio waves W1 by the communication device 100 to the communication target device 200A includes the identifier of the communication device that transmitted the signals and includes the identifier specifying the communication target device 200A as the destination.

For example, a user U functioning as the administrator can carry the communication device 100; children C1 and C2 representing the persons being managed can be made to carry the communication target devices 200; and, in order to ensure that the user U and the children C1 and C2 do not get separated from each other, the communication devices can be used in controlling the transmission output of the wireless communication and managing the situation via notifications.

### Configuration of Communication System

Explained below with reference to FIG. 2 is a configuration of the communication system 1 according to the application concerned. FIG. 2 is a diagram illustrating a configuration example of the communication system according to the application concerned. As illustrated in FIG. 2, the communication system 1 according to the application concerned includes the communication device 100, the communication target devices 200, and a network N. Given below is a brief explanation of those constituent elements.

The communication device 100 is an information processing device used by the user U. The communication device 100 can be an information processing device such as a smartphone, a tablet terminal, a wearable terminal, a cellular phone, or a personal digital assistant (PDA). In the example illustrated in FIG. 1, the communication device 100 is a smartphone.

Each communication target device 200 is an information processing device used by a child C who is target for management by the user U. The communication target device 200 can be an information processing device such as a smartphone, a tablet terminal, a wearable terminal, a cellular phone, or a personal digital assistant (PDA). In the example illustrated in FIG. 1, the communication target devices 200 are wearable terminals.

The network N connects the communication device 100 and the communication target devices 200 to each other in a wirelessly communicable manner. The network N can be implemented using Bluetooth (registered trademark) or using a wireless LAN defined in IEEE 802.11 (LAN stands for Local Area Network).

### Configuration of Communication Device

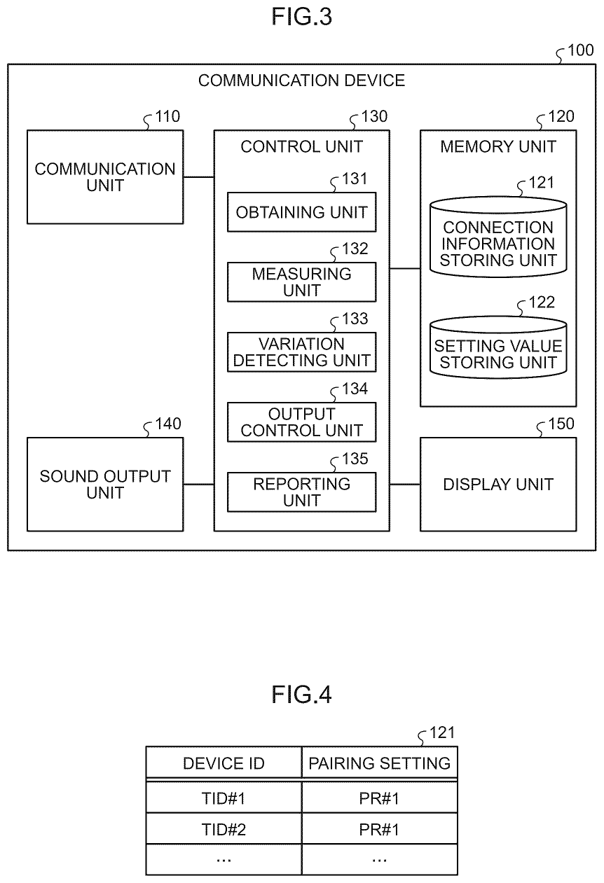

Explained below with reference to FIG. 3 is a configuration of the communication device according to the application concerned. FIG. 3 is a diagram illustrating a configuration example of the communication device according to the application concerned. As illustrated in FIG. 3, the communication device 100 according to the application concerned includes a communication unit 110, a memory unit 120, a control unit 130, a sound output unit 140, and a display unit 150. Given below is the explanation of those constituent elements one after another.

The communication unit 110 connects the inside of the communication device 100 to the outside in a communicable manner, and enables transmission and reception of information between the inside of the communication device 100 and the outside. The communication unit 110 can be implemented using, for example, a Bluetooth (registered trademark) module, a wireless LAN card (LAN stands for Local Area Network), a Wi-Fi (registered trademark) module, or an antenna. For example, the communication unit 110 is wirelessly connected to the communication target device 200, and transmits information to and receives information from the communication target device 200. That is, it can be said that the communication unit 110 performs wireless communication with the communication target device 200.

For example, the communication unit 110 periodically receives second-type signals that include: first-type radio wave reception strength information representing the radio field strength value of first-type radio waves received by the communication target device 200 from the communication device 100; and second-type radio wave transmission strength information (transmission power information) representing the transmission output value of second-type radio waves transmitted by the communication target device 200 to the communication device 100. Moreover, the communication unit 110 periodically transmits, to the communication target device 200, first-type signals that include: second-type radio wave reception strength information representing the radio field strength of the second-type radio waves, which are received from the communication target device 200, as measured by a measuring unit 132; and second-type radio wave transmission strength information (transmission power information) representing the transmission output value of the first-type radio waves transmitted by the communication device 100 to the communication target device 200.

The memory unit 120 is a storage device used to store a variety of information. The memory unit 120 includes a main storage device and an auxiliary storage device. The main storage device can be implemented using a semiconductor memory device such as a random access memory (RAM), a read only memory (ROM), or a flash memory. The auxiliary storage device can be implemented using, for example, a hard disk, a solid state drive (SSD), or an optical disc.

As illustrated in FIG. 3, the memory unit 120 includes a connection information storing unit 121 and a setting value storing unit 122. Given below is the explanation about the information stored in the those constituent elements.

### Regarding Connection Information Storing Unit 121

The connection information storing unit 121 stores therein connection information representing the information related to the wireless connection established with other devices. Explained below with reference to FIG. 4 is an example of the information stored in the connection information storing unit 121. FIG. 4 is a diagram illustrating an example of the information stored in the connection information storing unit of the communication device according to the application concerned.

In the example illustrated in FIG. 4, information about an item “device ID” and information about an item “pairing setting” is stored in a corresponding manner in the connection information storing unit 121.

The item “device ID” indicates the identifier that enables identification of the target device for pairing with respect to which a key exchange protocol is to be executed. The item “device ID” is expressed using characters and numerals. The item “pairing setting” indicates the information related to the setting about the pairing with the device that is identified by the item “device ID”. For example, the item “pairing setting” indicates the exchanged key or the profile.

Thus, in FIG. 4 is illustrated an example in which “PR #1” represents the connection information stored regarding the device identified by a device ID “TID #1”. For example, the information about the communication target device 200 is stored.

Meanwhile, the connection information storing unit 121 is not limited to storing the information related to the items “device ID” and “pairing setting”, and can store therein information related to some other arbitrary connection information.

### Regarding Setting Value Storing Unit 122

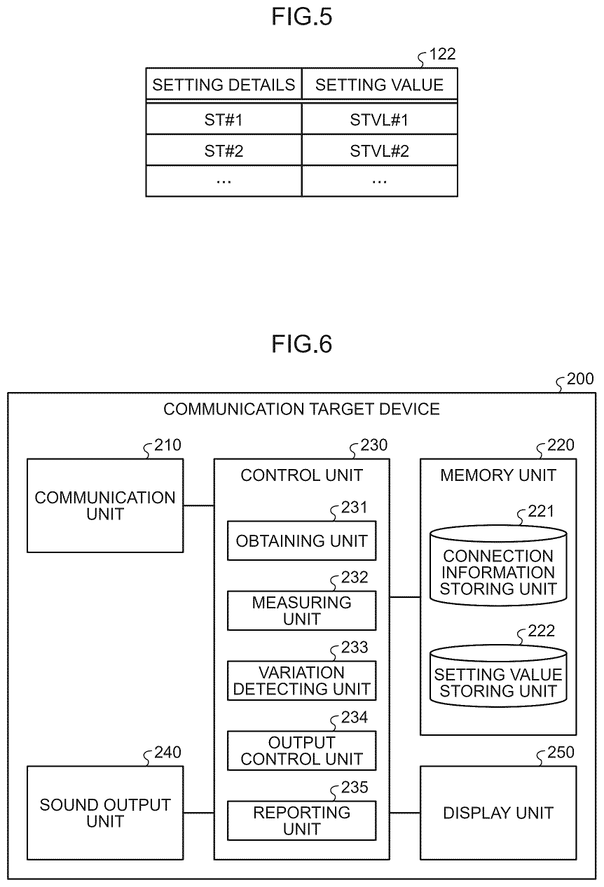

The setting value storing unit 122 stores therein the information related to a variety of setting values. Explained below with reference to FIG. 5 is an example of the information stored in the setting value storing unit 122. FIG. 5 is a diagram illustrating an example of the information stored in the setting value storing unit of the communication device according to the application concerned.

In the example illustrated in FIG. 5, information about an item “setting details” and information about an item “setting value” is stored in a corresponding manner in the setting value storing unit 122.

The item “setting details” indicates the naming of the parameter in which an arbitrary numerical value is set. For example, the item “setting details” indicates “transmission output value” or “variation in transmission output value per unit time”. The item “setting value” indicating the specific numerical value corresponding to the parameter specified in the item “setting details”. For example, the item “setting value” indicates a first threshold value or a second threshold value.

That is, in FIG. 5 is illustrated an example in which the parameter specified by setting details “ST #1″ is stored to have a setting value ”STVL #1″. For example, the information to be used in managing the communication target device 200 is stored.

Meanwhile, the setting value storing unit 122 is not limited to storing the information related to the items “setting details” and “setting value”, and can store therein information related to some other arbitrary connection information.

### Regarding Control Unit 130

The control unit 130 is a controller that controls the communication device 100. The control unit 130 is implemented when a central processing unit (CPU) or a micro processing unit (MPU) executes various computer programs, which are stored in the memory unit 120, using the RAM as the work area. Alternatively, the control unit 130 can be implemented using an integrated circuit such as an application specific integrated circuit (ASIC) or a field programmable gate array (FPGA).

As illustrated in FIG. 3, the control unit 130 includes an obtaining unit 131, a measuring unit 132, a variation detecting unit 133, an output control unit 134, and a reporting unit 135. When the computer programs (software) are read from the memory unit 120 and are executed, the control unit 130 implements the abovementioned functions and performs the corresponding operations. Meanwhile, the constituent elements of the control unit 130 can also be implemented using an electronic circuit. The control unit 130 either can perform the operations using a single a CPU, or can include a plurality of CPUs and perform the operations in parallel using those CPUs. Given below is the explanation of those constituent elements one after another.

The obtaining unit 131 obtains a variety of information via the communication unit 110. Given below is the explanation of a specific example of the information obtained by the obtaining unit 131.

For example, the obtaining unit 131 obtains, from the communication target device 200, the second-type signals that include: the first-type radio wave reception strength information representing the radio field strength value of the first-type radio waves received by the communication target device 200 from the communication device 100; and the second-type radio wave transmission strength information representing the transmission output value of the second-type radio waves transmitted by the communication target device 200 to the communication device 100. Herein, the transmission output value of the transmitted radio waves can be a numerical value corresponding to the RSSI value (RSSI stands for Received Signal Strength Indicator) that indicates the radio field strength value of the received radio waves. The RSSI value indicates the strength of the received signals in a receiver. Meanwhile, the transmission output value of the transmitted radio waves can alternatively indicate the transmission power value.

The measuring unit 132 measures the radio field strength value of the radio waves received by the communication unit 110. For example, as the second-type radio wave reception strength information that is measured, the measuring unit 132 outputs the radio field strength value of the second-type waves as received from the communication target device 200. That is, as the second-type radio wave reception strength information that indicates the measured radio field strength value of the second-type waves as received from the communication target device 200, the measuring unit 132 outputs the RSSI value. More particularly, as the RSSI value, the measuring unit 132 outputs the value that is proportional to the logarithm expressed in the unit of decibel microvolts (dBμV) of the input voltage of the received second-type radio waves.

The variation detecting unit 133 obtains the variation per unit time in the second-type radio wave transmission strength information included in the received second-type signals. For example, when the obtaining unit 131 obtains the second-type signals after every predetermined interval and obtains the transmission output value included in the second-type radio wave transmission strength information, the variation detecting unit 133 can divide, by the predetermined interval, the difference between the obtained transmission output value and the transmission output value of the second-type radio wave transmission strength information received before the current predetermined interval; and obtain the variation per unit time in the transmission output value of the second-type radio wave transmission strength information. The transmission output value of the second-type radio wave transmission strength information received before the current predetermined interval is stored in the memory unit 120.

The output control unit 134 controls the transmission output value of the communication unit 110. Given below is the explanation of a specific example of the manner in which the output control unit 134 controls the transmission output value.

The output control unit 134 controls the transmission output value of the communication device 100, which is to be transmitted to the communication target device 200, in such a way that the radio field strength value of the first-type radio waves received by the communication target device 200 is maintained at a constant level. For example, the radio field strength value of the first-type radio waves received by the communication target device 200 can be known by referring to the first-type radio wave reception strength information included in the second-type signals obtained by the obtaining unit 131. Based on the first-type radio wave reception strength information, when it is detected that there is a drop in the radio field strength of the first-type radio waves received by the communication target device 200, the output control unit 134 performs control to increase the transmission output. On the other hand, based on the first-type radio wave reception strength information, when it is detected that there is a rise in the radio field strength of the first-type radio waves received by the communication target device 200, the output control unit 134 performs control to lower the transmission output. Regarding the rise and the drop of the transmission output, the relationship between the received radio field strength value, the transmission output value, and the inter-device distance can be obtained in advance by means of actual measurement; and the control can be performed in such a way that the radio field strength value of the first-type radio waves received by the communication target device 200 is maintained at a constant level. In that case, the inter-device distance can be obtained from the transmission output value that is transmitted.

The reporting unit 135 reports abnormalities to the user. For example, the reporting unit 135 reports an abnormality to the user by causing the sound output unit 140 to output a voice message meant for reporting the abnormality to the user. Moreover, the reporting unit 135 reports an abnormality to the user by causing the display unit 150 to display a message meant for reporting the abnormality to the user. Given below is the specific explanation of the operations performed by the reporting unit 135.

When the transmission output value included in the second-type radio wave reception strength information, which is included in the second-type signals obtained by the obtaining unit 131, becomes equal to or greater than a first threshold value; the reporting unit 135 reports that the distance between the communication device 100 and the communication target device 200 has increased to be equal to or greater than a predetermined distance. Thus, the reporting unit 135 causes the sound output unit 140 to output a voice message that says “the distance from the communication target device 200 having the identification number ABC has increased to be equal to or greater than a predetermined distance”. Moreover, the reporting unit 135 can also cause the display unit 150 to display that message as a text message. Furthermore, when the variation in the transmission output value of the second-type radio wave transmission strength information as obtained by the variation detecting unit 133 becomes equal to or greater than a predetermined second threshold value, the reporting unit 135 reports that the distance from the communication target device 200 is rapidly increasing. Herein, the variation in the transmission output value of the second-type radio wave transmission strength information implies the variation in the radio field strength value per unit time. That is, when the variation per unit time in the transmission output value of the second-type radio wave transmission strength information as detected by the variation detecting unit 133 indicates an increase equal to or greater than a predetermined second threshold value, the reporting unit 135 reports to the user the fact that the distance between the communication target device 200 and the communication device 100 is rapidly increasing. When the distance between the communication target device 200 and the communication device 100 increases, the received radio field strength value undergoes attenuation. That is because, in order to maintain the received radio field strength value at a constant level, the transmission output value that is transmitted by the communication target device 200 needs to be increased. Meanwhile, the correspondence relationship between the transmission output value and the distance can be actually measured using the actual communication device 100 and the actual communication target device 200; the result of actual measurement can be stored in the memory unit 120; and the distance can be calculated based on the correspondence relationship between the transmission output value and the distance. When the amount of increase in the transmission output value of the second-type radio wave transmission strength information exceeds the threshold value, it becomes clear that the distance is rapidly increasing. Hence, the reporting unit 135 reports about that situation. That is, the reporting unit 135 causes the sound output unit 140 to output a voice message that says “the distance from the communication target device 200 having the identification number ABC is rapidly increasing”. Moreover, the reporting unit 135 can also cause the display unit 150 to display that message as a text message.

### Regarding Sound Output Unit 140

The sound output unit 140 outputs sounds such as voices. For example, the sound output unit 140 outputs a message, which is reported by the reporting unit 135, as a voice message. The sound output unit 140 can be a speaker that converts electrical signals into sounds using a diaphragm. That is, based on a control command issued using the electrical signals, the speaker causes the diaphragm to vibrate at a predetermined amplitude and with a predetermined vibration frequency, so that the diaphragm causes vibrations in the surrounding air thereby resulting in the output of sounds.

### Regarding Display Unit 150

The display unit 150 displays a variety of information to the user. For example, the display unit 150 displays a message, which is reported by the reporting unit 135, as a text message. The display unit 150 can be implemented using, for example, a liquid crystal display, an organic EL display (EL stands for Electro Luminescence), or a micro LED display (LED stands for Light Emitting Diode).

### Configuration of Communication Target Device

Explained below with reference to FIG. 6 is a configuration of the communication target device according to the application concerned. FIG. 6 is a diagram illustrating a configuration example of the communication target device according to the application concerned. As illustrated in FIG. 6, the communication target device 200 according to the application concerned includes a communication unit 210, a memory unit 220, a control unit 230, a sound output unit 240, and a display unit 250. Given below is the explanation of those constituent elements one after another.

The communication unit 210 connects the inside of the communication target device 200 to the outside in a communicable manner, and enables transmission and reception of information between the inside of the communication target device 200 and the outside. The communication unit 210 can be implemented using, for example, a Bluetooth (registered trademark) module, a wireless LAN card, a Wi-Fi (registered trademark) module, or an antenna.

For example, the communication unit 210 periodically receives the first-type radio waves of the first-type signals that include: the second-type radio wave reception strength information representing the radio field strength value of the second-type radio waves received by the communication device 100 from the communication target device 200; and the first-type radio wave transmission strength information (transmission power information) representing the transmission output value of the first-type radio waves transmitted by the communication device 100 to the communication target device 200. Moreover, the communication unit 210 periodically transmits, to the communication device 100, the second-type radio waves of the second-type signals that include: the first-type radio wave reception strength information representing the radio field strength value of the first-type radio waves, which are received from the communication device 100, as measured by a measuring unit 232; and the second-type radio wave transmission strength information (transmission power information) representing the transmission output value of the second-type radio waves transmitted by the communication target device 200 to the communication device 100.

The memory unit 220 is a storage device used to store a variety of information. The memory unit 220 includes a main storage device and an auxiliary storage device. The main storage device can be implemented using a semiconductor memory device such as a RAM, a ROM, or a flash memory. The auxiliary storage device can be implemented using, for example, a hard disk, an SSD, or an optical disc.

As illustrated in FIG. 6, the memory unit 220 includes a connection information storing unit 221 and a setting value storing unit 222. Given below is the explanation about the information stored in the those constituent elements. The information stored in the connection information storing unit 221 and the setting value storing unit 222 is same as the information stored in the connection information storing unit 121 and a setting value storing unit 122, respectively, of the memory unit 120 in the communication device 100. Hence, regarding the information stored in the connection information storing unit 221 and the setting value storing unit 222, the explanation is not given again.

The control unit 230 is a controller that controls the communication target device 200. The control unit 230 is implemented when a CPU or an MPU executes various computer programs, which are stored in the memory unit 220, using the RAM as the work area. Alternatively, the control unit 230 can be implemented using an integrated circuit such as an ASIC or an FPGA.

As illustrated in FIG. 6, the control unit 230 includes an obtaining unit 231, a measuring unit 232, a variation detecting unit 233, an output control unit 234, and a reporting unit 235. When the computer programs (software) are read from the memory unit 220 and are executed, the control unit 230 implements the abovementioned functions and performs the corresponding operations. Meanwhile, the constituent elements of the control unit 230 can also be implemented using an electronic circuit. The control unit 230 either can perform the operations using a single a CPU, or can include a plurality of CPUs and perform the operations in parallel using those CPUs. Given below is the explanation of those constituent elements one after another.

The obtaining unit 231 obtains a variety of information via the communication unit 210. Given below is the explanation of a specific example of the information obtained by the obtaining unit 231.

For example, the obtaining unit 231 obtains, from the communication device 100, the first-type signals that include: the second-type radio wave reception strength information representing the radio field strength value of the second-type waves received by the communication device 100 from the communication target device 200; and the first-type radio wave transmission strength information representing the transmission output value of the first-type radio waves transmitted by the communication device 100 to the communication target device 200. Herein, the transmission output value of the transmitted radio waves can be a value corresponding to the RSSI value.

The measuring unit 232 measures the radio field strength value of the radio waves received by the communication unit 210. For example, the measuring unit 232 outputs the first-type radio wave reception strength information that is received by the communication unit 210 from the communication device 100 and that represents the measured radio field strength value of the first-type radio waves. That is, as the first-type radio wave reception strength information that indicates the measured radio field strength value of the first-type waves as received from the communication device 100, the measuring unit 232 outputs the RSSI value. More particularly, as the RSSI value, the measuring unit 232 outputs the value that is proportional to the logarithm expressed in the unit of decibel microvolts amdBμV) of the input voltage of the received first-type radio waves.

The variation detecting unit 233 obtains the variation per unit time of the first-type radio wave transmission strength information included in the received first-type signals. For example, when the obtaining unit 231 obtains the first-type signals after every predetermined interval and obtains the transmission output value included in the first-type radio wave transmission strength information, the variation detecting unit 233 can divide, by the predetermined interval, the difference between the obtained transmission output value and the transmission output value of the first-type radio wave transmission strength information received before the current predetermined interval; and obtain the variation in the transmission output value of the first-type radio wave transmission strength information per unit time.

The output control unit 234 controls the transmission output value of the communication target device 200, which is to be transmitted to the communication device 100, in such a way that the radio field strength value of the second-type radio waves received by the communication device 100 is maintained at a constant level. For example, the radio field strength value of the second-type radio waves received by the communication device 100 can be known by referring to the second-type radio wave reception strength information included in the first-type signals obtained by the obtaining unit 231. Based on the second-type radio wave reception strength information, when it is detected that there is a drop in the radio field strength of the second-type radio waves received by the communication device 100, the output control unit 234 performs control to increase the transmission output. On the other hand, when it is detected that there is a rise in the radio field strength of the second-type radio waves, the output control unit 234 performs control to lower the transmission output. Regarding the rise and the drop of the transmission output, the relationship between the received radio field strength value, the transmission output value, and the inter-device distance can be obtained in advance by means of actual measurement, and the control can be performed in such a way that the radio field strength value of the second-type radio waves received by the communication device 100 is maintained at a constant level. In that case, the inter-device distance can be obtained from the transmission output value that is transmitted.

The reporting unit 235 reports abnormalities to the user. For example, the reporting unit 235 reports an abnormality to the user by causing the sound output unit 240 to output a voice message meant for reporting the abnormality to the user. Moreover, the reporting unit 235 reports an abnormality to the user by causing the display unit 250 to display a message meant for reporting the abnormality to the user. Given below is the specific explanation of the operations performed by the reporting unit 235.

When the transmission output value included in the first-type radio wave reception strength information, which is included in the first-type signals obtained by the obtaining unit 231, becomes equal to or greater than the first threshold value; the reporting unit 235 reports that the distance between the communication target device 200 and the communication device 100 has increased to be equal to or greater than a predetermined distance. Thus, the reporting unit 235 causes the sound output unit 240 to output a voice message that says “the distance from the communication device 100 has increased to be equal to or greater than a predetermined distance”. Moreover, the reporting unit 235 can also cause the display unit 250 to display that message as a text message. Furthermore, when the variation in the transmission output value of the first-type radio wave transmission strength information as obtained by the variation detecting unit 233 becomes equal to or greater than the predetermined second threshold value, the reporting unit 235 reports that the distance from the communication device 100 is rapidly increasing. Herein, the variation in the transmission output value of the first-type radio wave transmission strength information implies attenuation in the transmission output value per unit time. That is, when the variation per unit time in the transmission output value of the first-type radio wave transmission strength information as detected by the variation detecting unit 233 indicates an increase equal to or greater than the predetermined second threshold value, the reporting unit 235 reports to the user the fact that the distance between the communication device 100 and the communication target device 200 is rapidly increasing. Meanwhile, the correspondence relationship between the transmission output value and the distance can be actually measured using the actual communication device 100 and the actual communication target device 200; the result of actual measurement can be stored in the memory unit 220; and the distance can be calculated based on the correspondence relationship between the transmission output value and the distance. When the amount of increase in the transmission output value of the first-type radio wave transmission strength information exceeds the threshold value, it becomes clear that the distance is rapidly increasing. Hence, the reporting unit 235 reports about that situation. That is, the reporting unit 235 causes the sound output unit 240 to output a voice message that says “the distance from the communication device 100 is rapidly increasing”. Moreover, the reporting unit 235 can also cause the display unit 250 to display that message as a text message.

The sound output unit 240 outputs sounds such as voices. For example, the sound output unit 240 outputs a message, which is reported by the reporting unit 235, as a voice message. The sound output unit 240 can be a speaker that converts electrical signals into sounds using a diaphragm. That is, based on a control command issued using the electrical signals, the speaker causes the diaphragm to vibrate at a predetermined amplitude and with a predetermined vibration frequency, so that the diaphragm causes vibrations in the surrounding air thereby resulting in the output of sounds.

The display unit 250 displays a variety of information to the user. For example, the display unit 250 displays a message, which is reported by the reporting unit 235, as a text message. The display unit 250 can be implemented using, for example, a liquid crystal display, an organic EL display, or a micro LED display.

First way of implementation of communication method

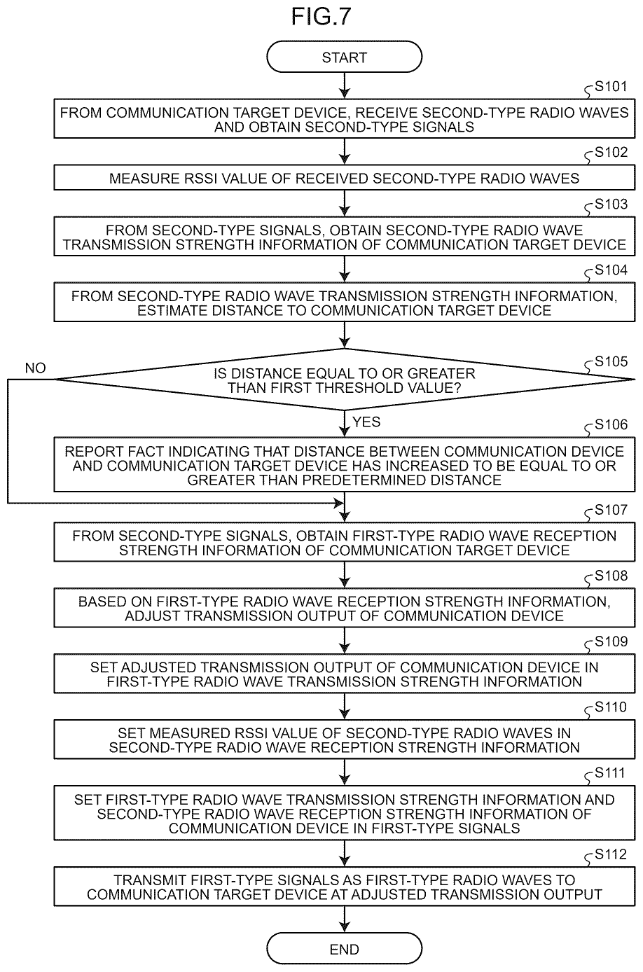

Explained below with reference to FIG. 7 is a first way of implementation of a communication method according to the application concerned. FIG. 7 is a flowchart for explaining the flow of the first way of implementation of the communication method according to the application concerned. Thus, the first way of implementation of the communication method according to the application concerned is explained in a stepwise manner with reference to the flow illustrated in FIG. 7.

Firstly, the communication device 100 receives second-type radio waves from the communication target device 200 and obtains second-type signals (Step S101). Then, the communication device 100 measures the RSSI value of the received second-type radio waves (Step S102). Subsequently, from the second-type signals, the communication device 100 obtains the second-type radio wave transmission strength information of the communication target device 200 (Step S103). From the second-type radio wave transmission strength information, the communication device 100 estimates the distance from the communication target device 200 (Step S104). Then, the communication device 100 determines whether or not the distance is equal to or greater than the first threshold value (Step S105). When the distance is equal to or greater than the threshold value (Yes at Step S105), it is reported that the distance between the communication device 100 and the communication target device 200 has increased to be equal to or greater than a predetermined distance (Step S106). Then, from the second-type signals, the communication device 100 obtains the first-type radio wave reception strength information of the communication target device 200 (Step S107). Subsequently, based on the first-type radio wave reception strength information, the communication device 100 adjusts the transmission output of the communication device 100 (Step S108). Then, the communication device 100 sets the adjusted transmission output of the communication device 100 in the first-type radio wave transmission strength information (Step S109). Subsequently, the communication device 100 sets the measured RSSI value of the second-type radio waves in the second-type radio wave reception strength information (Step S110). Then, the communication device 100 sets the first-type radio wave transmission strength information and the second-type radio wave reception strength information of the communication device 100 in the first-type signals (Step S111). Subsequently, the communication device 100 transmits the first-type signals as the first-type radio waves to the communication target device 200 at the adjusted transmission output (Step S112).

Meanwhile, at Step S105, when the distance is not equal to or greater than the threshold value (No at Step S105), the system control proceeds to Step S107 and the communication device 100 performs the subsequent operations.

The first way of implementation explained above either can be implemented by the communication device 100 or can be implemented using a computer program that causes the computer of the control unit 130 of the communication device 100 to perform the operations.

As a result, at the time when the communication target device 200 receives the radio waves transmitted from the communication device 100, since the communication device 100 becomes able to know the RSSI value, the transmission output value of the communication device 100 can be controlled in such a way that the RSSI value of the radio waves received by the communication target device 200 is maintained at a constant level. For that reason, even when the distance between the communication device 100 and the communication target device 200 increases, the wireless communication can be carried out without interruption. Hence, a communication method can be provided that enables maintaining uninterrupted connectivity between the communication device 100 and the communication target device 200.

### Second Way of Implementation of Communication Method

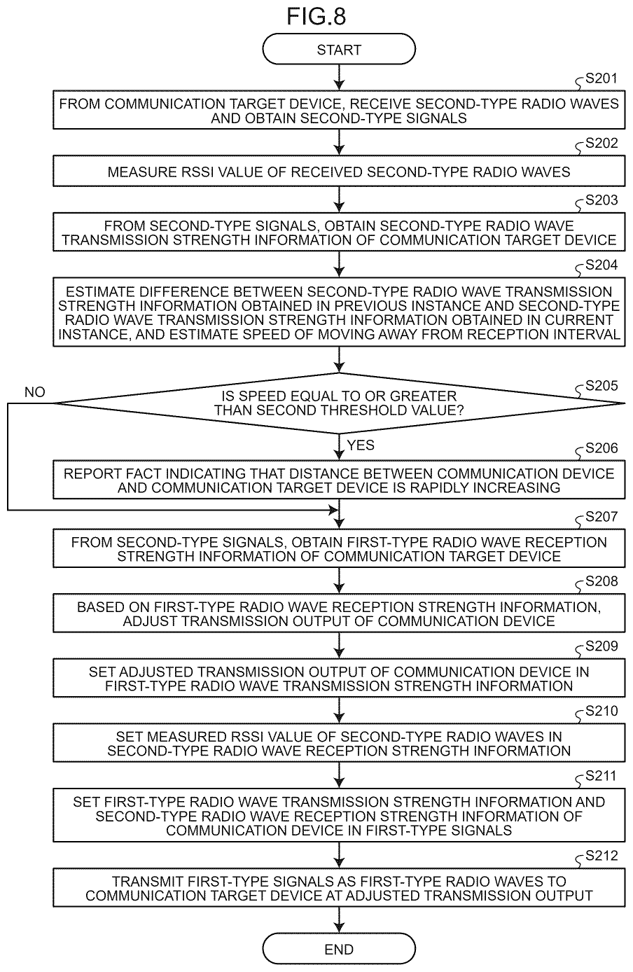

Explained below with reference to FIG. 8 is a second way of implementation of the communication method according to the application concerned. FIG. 8 is a flowchart for explaining the flow of the second way of implementation of the communication method according to the application concerned. Thus, the second way of implementation of the communication method according to the application concerned is explained in a stepwise manner with reference to the flow illustrated in FIG. 8.

Firstly, the communication device 100 receives second-type radio waves from the communication target device 200 and obtains second-type signals (Step S201). Then, the communication device 100 measures the RSSI value of the received second-type radio waves (Step S202). Subsequently, from the second-type signals, the communication device 100 obtains the second-type radio wave transmission strength information of the communication target device 200 (Step S203). Then, the communication device 100 estimates the difference between the second-type radio wave transmission strength information obtained in the previous instance and the second-type radio wave transmission strength information obtained in the current instance, and estimates the speed of moving away from the reception interval (Step S204). Subsequently, the communication device 100 whether or not the speed is equal to or greater than the second threshold value (Step S205). When the speed is equal to or greater than the second threshold value (Yes at Step S205), the communication device 100 reports that the distance from the communication target device 200 is rapidly increasing (Step S206). Then, from the second-type signals, the communication device 100 obtains the first-type radio wave reception strength information of the communication target device 200 (Step S207). Subsequently, based on the first-type radio wave reception strength information, the communication device 100 adjusts the transmission output of the communication device 100 (Step S208). Then, the communication device 100 sets the adjusted transmission output of the communication device 100 in the first-type radio wave transmission strength information (Step S209). Subsequently, the communication device 100 sets the measured RSSI value of the second-type radio waves in the second-type radio wave reception strength information (Step S210). Then, the communication device 100 sets the first-type radio wave transmission strength information and the second-type radio wave reception strength information of the communication device 100 in the first-type signals (Step S211). Subsequently, the communication device 100 transmits the first-type signals as the first-type radio waves to the communication target device 200 at the adjusted transmission output (Step S212).

Meanwhile, at Step S205, when the speed is not equal to or greater than the second threshold value (No at Step S205), the system control proceeds to Step S207 and the communication device 100 performs the subsequent operations.

Thus, when the speed of moving away is equal to or greater than the second threshold value, the fact that the distance between the communication device 100 and the communication target device 200 is rapidly increasing can be reported to the user. Moreover, even when the distance between the communication device 100 and the communication target device 200 is rapidly increasing, the communication device 100 can take measures to ensure uninterrupted communication with the communication target device 200. Hence, a communication method can be provided that enables maintaining uninterrupted connectivity between the communication device 100 and the communication target device 200.

### Communication Method in Communication System

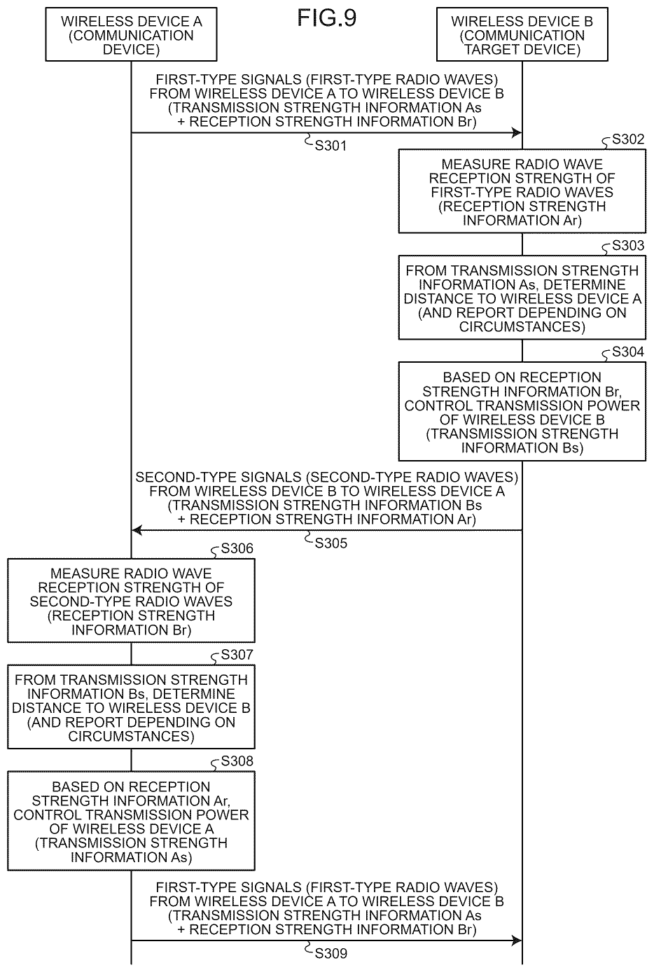

Explained below with reference to FIG. 9 is a communication method implemented in the communication system 1 according to the application concerned. FIG. 9 is a flowchart for explaining the flow of a implementation of a communication method performed in the communication system according to the application concerned. Thus, the communication method implemented in the communication system 1 according to the application concerned is explained in a stepwise manner with reference to the flow illustrated in FIG. 9.

Firstly, the communication device 100 (a wireless device A) transmits first-type signals (first-type radio waves) including the transmission radio field strength information (transmission radio field strength information As) and the reception radio field strength information (reception radio field strength information Br) (Step S301). Then, the communication target device 200 (a wireless device B) measures the radio field strength of the first-type waves (reception radio field strength information Ar) transmitted from the communication device 100 (the wireless device A) (Step S302). Subsequently, from the transmission strength information As included in the first-type signals, the communication target device 200 determines the distance from the communication device 100 (the wireless device A) (Step S303). Moreover, at Step S303, the communication target device 200 can report the determined distance to the communication device 100. Then, based on the reception strength information Br included in the first-type signals, the communication target device 200 controls the transmission output value (transmission strength information Bs) thereof (Step S304).

Subsequently, the communication target device 200 transmits, to the communication device 100, second-type signals that include the transmission radio field strength information (the transmission radio field strength information Bs) and the reception radio field strength information (the reception radio field strength information Ar) (Step S305). Then, the communication device 100 measures the radio wave reception strength (the reception strength information Br) of the second-type waves transmitted from the communication target device 200 (Step S306). Subsequently, from the transmission strength information Bs, the communication device 100 determines the distance from the communication target device 200 (the wireless device B) (Step S307). Moreover, at Step S307, the communication device 100 can also report the determined distance to the communication target device 200. Then, based on the reception strength information Ar, the communication device 100 controls the transmission output value (the transmission strength information As) of the communication device 100 (Step S308). Subsequently, the communication device 100 transmits, to the communication target device 200, the first-type signals (the first-type radio waves) that include the transmission radio field strength information As and the reception radio field strength information Br (Step S309).

Thus, the communication device 100 and the communication target device 200 can transmit and receive the transmission output values and the reception radio field strength values between themselves. For that reason, the communication device 100 and the communication target device 200 become able to obtain the information that serves as the basis for controlling the corresponding transmission output values to ensure uninterrupted communication between the two devices. Meanwhile, between two communication target devices 200 too, the transmission output values and the reception radio field strength values can be transmitted and received, and the fact that the distance has increased can be reported based on the transmission output values. With reference to FIG. 1, the communication target devices 200A and 200B can perform communication, and the communication target device 200A (200B) can report that “the distance from the communication target device 200B (200A) is rapidly increasing”.

### Configuration and Effects

The communication device 100 according to the application concerned includes: the communication unit 110 that performs wireless communication with other communication devices; the obtaining unit 131 that obtains a variety of information via the communication unit 110; the output control unit 134 that controls the transmission output value of the communication unit 110; and the reporting unit 135 that reports abnormalities to the user. The obtaining unit 131 obtains, from another communication device, the second-type signals of the second-type radio waves that include: the first-type radio wave reception strength information representing the radio field strength value of the first-type radio waves received by the other communication device from the concerned communication device 100; and the second-type radio wave transmission strength information representing the transmission output value of the second-type radio waves transmitted by the other communication device. The output control unit 134 controls the transmission output value of the first-type waves, which are transmitted to the other communication device, in such a way that the received first-type radio wave reception strength is maintained at a constant level.

According to such a configuration, the transmission output value of the communication device 100 can be controlled in such a way that the first-type radio wave reception strength, which represents the radio field strength of the radio waves received by the communication target device 200 from the communication device 100, is maintained at a constant level. For that reason, it becomes possible to provide the communication device 100 that is capable of stably maintaining the connectivity with the communication target device 200.

In the communication device 100 according to the application concerned, when the received second-type radio wave transmission strength information becomes equal to or greater than the predetermined first threshold value, the reporting unit 135 reports that the distance between the other communication device and the communication device 100 has increased to be equal to or greater than a predetermined distance.

According to such a configuration, when the second-type radio wave transmission strength information received by the communication device 100 becomes equal to or greater than a predetermined threshold value, it becomes possible to report that the distance between the other communication device and the communication device 100 has increased to be equal to or greater than a predetermined distance. Moreover, it becomes possible to provide the communication device 100 that, even when the distance from the communication target device 200 has increased, is capable of maintaining uninterrupted connectivity with the communication target device 200.

The communication device 100 according to the application concerned further includes the measuring unit 132 that measures the radio field strength value of the radio waves received by the communication unit 110. The measuring unit 132 outputs the second radio field strength value of the second-type radio waves, which are received by the communication unit 110 from another communication device, as the second-type radio wave reception strength information; the output control unit 134 outputs the transmission output value of the first-type radio waves, which are transmitted by the communication unit 110 to the other communication device, as the first-type radio wave transmission strength information; and the communication unit 110 transmits, to the other communication device, the first-type signals that include the second-type radio wave reception strength information and the first-type radio wave transmission strength information.

According to such a configuration, the communication device 100 can transmit, to another device, the first-type signals, which include the second-type radio wave reception strength information and the first-type radio wave transmission radio strength information, as the first-type radio waves. Hence, the other communication device that receives the first-type signals can control the transmission output value of the communication target device 200 based on the second-type radio wave reception strength information. For that reason, it becomes possible to provide the communication target device 200 that enables maintaining uninterrupted connectivity with the communication device 100.

The communication device 100 according to the application concerned further includes the variation detecting unit 133 that obtains the variation per unit time of the received second-type radio wave transmission strength information. The communication unit 110 periodically receives the second-type signals; and, when the variation becomes equal to or greater than the predetermined threshold value, the reporting unit 135 reports that the distance between the other communication device and the communication device 100 is rapidly increasing.

According to such a configuration, when the variation per unit time in the second-type radio wave transmission strength, which is received by the communication device 100 from the communication target device 200, becomes equal to or greater than the predetermined second threshold value, it becomes possible to report the fact that the communication target device 200 is rapidly moving away from the communication device 100. Moreover, it becomes possible to provide the communication device 100 that, even when the distance between the communication device 100 and the communication target device 200 has increased, enables maintaining uninterrupted connectivity with the communication target device 200.

The communication method according to the application concerned includes: performing wireless communication with another communication device; obtaining a variety of information using the wireless communication; controlling the transmission output value of the wireless communication; and reporting an abnormality to the user. The obtaining includes, from the other communication device, second-type signals of second-type radio waves that include: first-type radio wave reception strength information, which represents the radio field strength value of first-type radio waves received by the other communication device from the communication device 100; and second-type radio wave transmission strength information representing the transmission output value of the second-type radio waves transmitted by the other transmission device. The controlling includes controlling the transmission output value of the first-type radio waves, which are transmitted to the other communication device, in such a way that the received first-type radio wave reception strength is maintained at a constant level.

According to such a configuration, the transmission output value of the communication device 100 can be controlled in such a way that the first-type radio wave reception strength, which represents the radio field strength value of the radio waves received by the communication target device 200 from the communication device 100, is maintained at a constant level. For that reason, it becomes possible to provide a communication method that makes it possible to maintain stable connectivity between the communication device 100 and the communication target device 200.

Meanwhile, the communication device 100 and the communication target device 200 can be configured to have the same functions; and the transmission output value of the communication target device 200 can be controlled in such a way that the second-type radio wave reception strength, which represents the radio field strength value of the radio waves received by the communication device 100 from the communication target device 200, is maintained at a constant level. For that reason, the connectivity between the communication target device 200 and the communication device 100 can be maintained in a stable manner.

The application concerned contributes to the “sustainable cities and communities” of the SDGs (Sustainable Development Goals), and includes items that contribute in ensuring safety and security of public facilities.

According to the application concerned, a communication device and a communication method can be provided by which the distance between communication devices can be identified while maintaining stable connectivity between the communication devices.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A communication device comprising:
a communication unit that performs wireless communication with another communication device;
an obtaining unit that obtains a variety of information via the communication unit; and
an output control unit that controls transmission output value of the communication unit, wherein
the obtaining unit obtains, from the other communication device, second-type signal of second-type radio wave including first-type radio wave reception strength information, which represents radio field strength value of first-type radio wave received by the other communication device from the communication device, and second-type radio wave transmission strength information, which represents transmission output value of second-type radio wave transmitted by the other communication device, and
the output control unit controls transmission output value of the first-type radio wave, which is transmitted to the other communication device, in such a way that the received first-type radio wave reception strength information is maintained at a constant level.

2. The communication device according to claim 1, further comprising a reporting unit that reports an abnormality to a user, wherein
when the received second-type radio wave transmission strength information becomes equal to or greater than a predetermined first threshold value, the reporting unit reports that distance between the other communication device and the communication device has increased to be equal to or greater than a predetermined distance.

3. The communication device according to claim 1, further comprising a measuring unit that measures radio wave strength value of radio wave received by the communication unit, wherein
the measuring unit outputs, as second-type radio wave reception strength information, radio field strength value of the second-type radio wave received by the communication unit from other communication device,
the output control unit outputs, as first-type radio wave transmission strength information, transmission output value of the first-type radio wave transmitted by the communication unit to the other communication device, and
the communication unit transmits, as the first-type radio wave to the first communication device, first-type signal including the second-type radio wave reception strength information and the first-type radio wave transmission strength information.

4. The communication device according to claim 2, further comprising a variation detecting unit that detects variation per unit time of the received second-type radio wave transmission strength information, wherein
the communication unit periodically receives the second-type signal, and
when the variation becomes equal to or greater than a second threshold value, the reporting unit reports that distance between the other communication device and the communication device is rapidly increasing.

5. A communication method comprising:
performing wireless communication with another communication device;
obtaining a variety of information using the wireless communication; and
controlling transmission output value of the wireless communication, wherein
the obtaining includes obtaining, from the other communication device, second-type signal of second-type radio wave that includes first-type radio wave reception strength information, which represents radio field strength value of first-type radio wave received by the other communication device from concerned communication device, and second-type radio wave transmission strength information, which represents transmission output value of the second-type radio wave transmitted by the other communication device, and
the controlling includes controlling transmission output value of the first-type radio wave, which is transmitted to the other communication device, in such a way that the received first-type radio wave reception strength is maintained at a constant level.
